(19) United States
(12) Patent Application Publication
(10) Pub. No.: US 2023/0016142 A1
(43) Pub. Date: Jan. 19, 2023

(54) CONNECTED BAG FOR TRANSPORTING FRAGILE OBJECTS

(71) Applicants: Afida BENSAOUD, Chennevières-sur-Marne (FR); Xavier RICHARD, Chennevières-sur-Marne (FR)

(72) Inventors: Afida BENSAOUD, Chennevières-sur-Marne (FR); Xavier RICHARD, Chennevières-sur-Marne (FR)

(21) Appl. No.: 17/757,391

(22) PCT Filed: Aug. 17, 2020
(86) PCT No.: PCT/FR2020/051475

§ 371 Date: Jun. 15, 2022

(30) Foreign Application Priority Data
Dec. 19, 2019 (FR) 1914974

(51) Int. Cl. A45C 13/24; A45C 15/06; A45C 13/02; G06K 19/14

(52) U.S. Cl. CPC A45C 13/24; A45C 15/06; A45C 13/02; G06K 19/145; A45C 2011/007

(57) ABSTRACT

The application relates to a bag for transporting fragile objects, including a rigid or semi-rigid outer envelope delimiting an internal volume, partitioning elements for partitioning said internal volume, means for opening the envelope in order to access the internal volume, and means for linking to a carrier. The bag further includes a security device arranged so as to cooperate with the opening means.

### TECHNICAL FIELD OF THE INVENTION

The invention relates to the field of bags for transporting fragile objects, to be worn by a person. Backpacks are more particularly targeted by the invention and, in particular but not exclusively, backpacks for transporting food. Transport bags in the medical field, such as bags for first aid workers fall within the scope of the invention.

### PRIOR ART

Backpacks are known for transporting fresh food products that have to be transported from their place of production to the homes of individuals who have ordered them. The dispatch riders who transport these fresh products have to do so within a minimal time in order for the products to be delivered in a good state of conservation, to the purchasers. The known backpacks are generally of cubic or parallelepipedal form; their outer envelope is rigid or semi-rigid, generally impermeable; partitioning elements are provided inside the volume delimited by the outer envelope, in order to define separate volumes for example multiple food types; hot, cold, more or less bulky, more or less soft, flexible or rigid. In this respect, these are fragile products that have to be transported as delicately as possible despite the random factor involved in the type of transportation. The partitioning elements can have rigid pads provided with Velcro-type strips which extend beyond them and which allow them to be removably fixed onto the inner walls of the envelope, more specifically, to Velcro type strips fixed to the inner walls. The document US 2016 0316877 discloses a bag for transporting objects comprising partitioning elements arranged in its internal volume in order to divide up this volume.

When transporting the products to be delivered on his or her back, the dispatch rider may use a bicycle or a motor cycle for a more or less lengthy time: from a few minutes to a half hour for example.

Regarding first aid workers, they may have to travel on foot for long distances with their bag fixed onto their shoulders; weight and security are thus crucial parameters for this type of application.

Thus, the known bags fulfil functions that are important to the quality of transportation and/or the comfort of the dispatch rider or the first aid worker—carrier.

The known bags also comprise means for opening the outer envelope, on at least one of the faces of the envelope. Face portions are therefore subdivided and provided with closure means of zipper closure type in order to constitute removable outer jacket opening means, for accessing the internal volume of the envelope. Obviously, links means with the carrier, such as straps, allow the bag to be fixed onto the back of the carrier.

In addition, the known backpacks may be foldable, once unloaded, to be able to be folded. The patent U.S. Pat. No. 0,060,581 B1 describes a foldable picnic bag. Likewise, the document U.S. Pat. No. 5,316,388 A discloses a foldable transport bag.

Regarding the elements separating the internal volumes of the food transport bags, the patent U.S. Pat. No. 9,498,036 B1 discloses such a flexible element and one of which the temperature can be controlled. Within the same field, the patent U.S. Pat. No. 6,947,664 B1 mentions a portable picnic bag in which the foods in the internal volume can be maintained at a constant temperature. Regarding the heating of such bags, there is the application WO 2000 050307 A2 which describes a food transport container of which the walls incorporate heating resistors capable of heating the foods. Also known is a so-called picnic bag that makes it possible to cool the foods contained inside.

It can be seen that multiple and varied functions are provided, correlated with the known food transport bags.

However, it is sought to enhance such bags, notably in terms of traceability, of security, both of the products or objects transported, and of the carrier. The invention relates in particular to the objects or products that are fragile. “Fragile” is understood to mean any object, product, even animal or baby that has to be transported in a particular way in precise and controlled temperature, pressure and other such conditions. Tracking and/or traceability are also sought.

### SUMMARY OF THE INVENTION

The invention aims to remedy the drawbacks of the state of the art and notably propose a bag for transporting fragile products, capable in particular of providing tracking, traceability and security of the products transported and/or of the carrier. The transporting of perishable foods is particularly targeted by the invention.

For this, according to a first aspect of the invention, a bag for transporting fragile objects is proposed, comprising a rigid or semi-rigid outer envelope delimiting an internal volume, partitioning elements for partitioning said internal volume, means for opening the envelope to access the internal volume, means for linking with a carrier. According to the invention, the bag further comprises connector link means capable of locating said bag and/or said carrier and/or of delivering in real time information on the objects transported; a standalone power source of battery type is provided, linked to at least one port of USB jack type.

The object here is to provide a bag for transporting fragile products which is “smart”, that is to say provided with functions that are not as yet provided by the prior art and that advantageously make the objectives described above possible.

In particular, the transport bag further comprises means for securing the carrier such as light source, airbags. This for example involves providing a light signal on the outer surface of the bag, capable of indicating any change of direction of movement, notably of the carrying cyclist or motor cyclist. The airbag type devices are preferentially placed on the shoulder straps of the bag, between the bag and the carrier for safety purposes.

Preferably, the transport bag can comprise a magnetic card to identify the carrier and/or the bag via an application implanted in an external communication means of cellphone type, for storing and/or transmitting information in real time. Once again, protection and the traceability of the carrier and/or of the bag are, here, enhanced by this feature.

More specifically, the information on the transported objects relates to their weight and/or their temperatures and/or the relative humidity of the internal volume of the bag. For this, at least one weight sensor and/or at least one temperature sensor and/or at least one moisture sensor concerning the internal volume of the bag, functionally linked to a processing means external to the bag and/or to said magnetic card.

According to another feature, the transport bag further comprises means for heating or cooling said internal volume, powered by the power source. Said means can advantageously be controlled in situ or remotely.

Furthermore, the bag according to the invention comprises display means fixed onto the outer surface of the envelope, powered or not by the power source.

Without departing from the scope of the invention, the bag further comprises soundboard casting means powered by the power source and capable of cooperating with digital files transmitted from at least one external source.

Advantageously, the transport bag further comprises at least one camera and at least one LED cooperating with the means for opening the envelope and connecting means in order to control, and/or record the displacement of said opening means. Control and therefore traceability are thus possible; any theft of or breaking into the product present inside the bag can here be checked and/or prevented.

Moreover, the bag according to the invention can comprise at least one camera fixed onto the outer envelope, powered by said power source and capable of recording, and/or transmitting information relating to the environment of said bag in real time.

### BRIEF DESCRIPTION OF THE FIGURES

Other features and advantages of the invention will emerge on reading the following description, with reference to the attached drawings, which illustrate:

FIG. 1 a front view of a connected bag according to a first embodiment of the invention;

FIG. 2 a rear view of a connected bag according to the first embodiment of the invention;

FIG. 3 a side view of a connected bag according to the first embodiment of the invention;

FIG. 4 a front view of a connected bag according to a second embodiment of the invention;

FIG. 5 a rear view of a bag according to the second embodiment of the invention;

FIG. 6 a diagram of a feature of a connected bag according to the invention;

FIG. 7 diagrams of a bag according to the invention seen from the front, and other features;

FIG. 8 a front view of a connected bag according to another embodiment of the invention;

FIG. 9 a side view of a connected bag according to yet another embodiment of the invention;

FIG. 10 a view of a bag according to yet another embodiment of the invention;

FIG. 11 a three-dimensional view of a bag according to yet another embodiment;

FIG. 12 is a three-dimensional detail view of an inner face of a security device of the bag of FIG. 11;

FIG. 13 is a front view of the inner face of the security device of FIG. 12; and,

FIG. 14 is a view of the outer face of the security device of FIG. 12.

For greater clarity, the elements that are identical or similar are identified by identical reference symbols throughout the figures.

### DETAILED DESCRIPTION OF AN EMBODIMENT

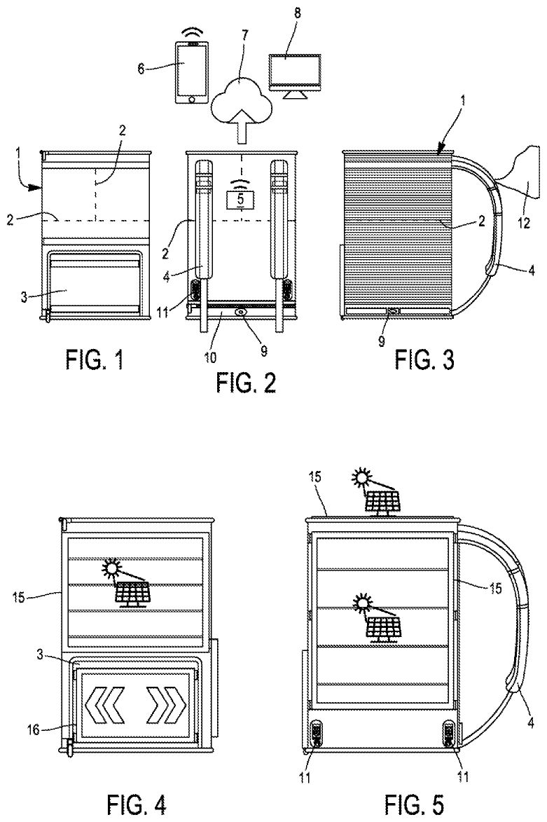

FIG. 1 schematically shows a first embodiment of the invention; it can be seen that the connected bag for transporting fragile objects comprises a rigid or semi-rigid outer envelope 1 in order, here, to have a parallelepipedal outer form. Other outer forms can be envisaged within the scope of the invention. The internal volume delimited by the envelope 1 can comprise partitioning elements 2, according to requirements. Here, a horizontal partitioning element 2 and a vertical partitioning element are illustrated.

FIG. 1 also shows means 3 for opening the envelope 1, for access to the internal volume. These opening means can for example take the form of a part of the front face of the bag, cut in order to form a rectangular flap permanently linked to the bag by its bottom length (close to the bottom of the bag) and removably linked by a closure of zipper closure type. This example is illustrative. A second opening of the same type can be provided on the top face of the bag in order to partially or totally uncover it.

FIG. 2 also shows means for linking 4 with the carrier of the bag, in the form of two shoulder straps. In FIG. 2, connector link means capable of locating the bag can also be seen; these means correspond here to a magnetic card 5 connected to the network notably allowing the carrier to be identified via an application implanted on a device of smartphone type 6, to transmit and/or to store data to a given “cloud” 7, to supply information in real time to a particular reception means 8. “Cloud” or “computer cloud” is understood to mean a set of hardware, network connections and software providing services that can be operated by anyone in the world, at will.

Moreover, a standalone power source of battery type 9 can be inserted, for example, into a volume of the bottom part of the bag. This volume consists of a pocket that is closed removably, for example by a zipper closure or any equivalent means. The battery 9 can be recharged via an appropriate connection (not represented) to an electrical outlet. According to a particular aspect of the invention, the battery 9 is linked by interactive means to ports of USB jack 11 type fixed to the envelope of the bag and preferably covered by flexible tabs in order to protect them, notably from moisture.

Furthermore, as can be seen in FIG. 3, an impact protection means 12 of airbag type, can be fixed, for example, to the shoulder straps 4.

FIGS. 4 and 5 show another embodiment of the invention according to which at least one solar panel 15 is fixed onto at least one of the outer faces of the bag. FIG. 4 shows a solar panel 15 fixed onto the front face of the bag, above the opening 3. The solar panel or panels 15 are preferentially fixed removably, for example by Velcro® strips. FIG. 5 shows one panel fixed onto the side face of the bag and another onto the top of the bag. The solar panels 15 are connected and transfer their power using the USB jack ports 11 provided. FIG. 4 also shows a screen 16 fixed, preferentially removably, onto the movable and removable opening 3. The screen 16 can be a digital screen capable of displaying various information. A display can be designed in the form of symbols or arrows capable of signaling a change of direction of the bag worn by a moving carrier. Any other form of dynamic display can of course be provided.

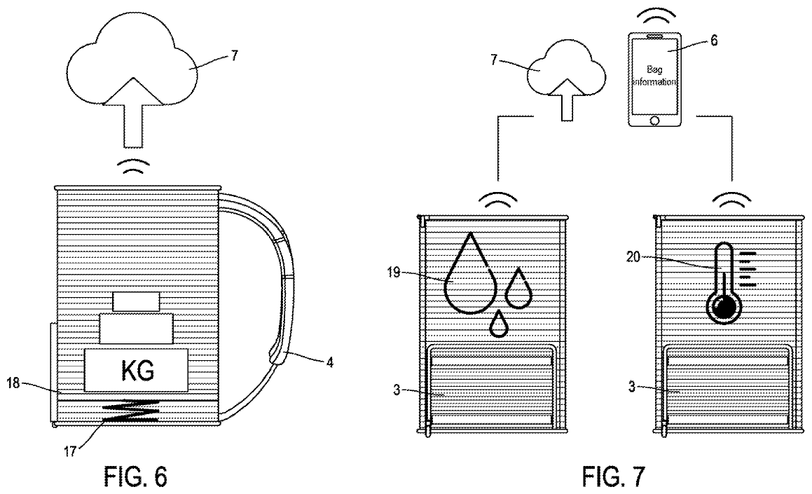

FIG. 6 shows a connected bag capable of transmitting information on the weight of the object or objects transported. For this, a weight sensor 17 is mounted in the bottom part of the bag; the object or objects are supported by a plate 18. The sensor 17 is linked and transmits in real time the weight of the object transported, preferably to the cloud of the company. This information is advantageous in that it allows real time traceability of the weight and therefore of the state of progress of the delivery.

FIG. 7 describes another feature of the invention, at least one relative humidity sensor 19 is fixed in the internal volume of the bag. A temperature sensor 20 can be provided in this same space. This sensor or these sensors is or are linked to the cloud of the company 7 and/or to the smartphone 6 of the carrier; this makes it possible to transmit in real time information on the volume in which the object or objects to be transported are stored. It will be understood that, for perishable or fragile foodstuffs, this type of information is vital. Not only is it possible to monitor in real time that the temperature and/or the relative humidity are acceptable, but, if these data are stored, a traceability is obtained providing knowledge on the real and unquestionable transport conditions.

Another innovative feature of the invention relates to the fitting of a video camera in at least one point of the outer surface of the bag: one video camera can be fixed onto the front face of the bag and at least one other onto a side face. These cameras are powered by the standalone power source 9 and they make it possible to transmit, in real time to the cloud of the company, visual information on the environment of the bag and/or of the carrier. Protection is thus provided. With the same idea in mind, a camera associated with an LED can be fixed onto or in proximity to the removable opening 3 or other openings of the same type; their operation can be triggered by the movement of the removal opening. Thus, any displacement of the opening or of the openings is monitored. Once again, this is useful in real time for monitoring the transported objects, and subsequently for tracing said objects.

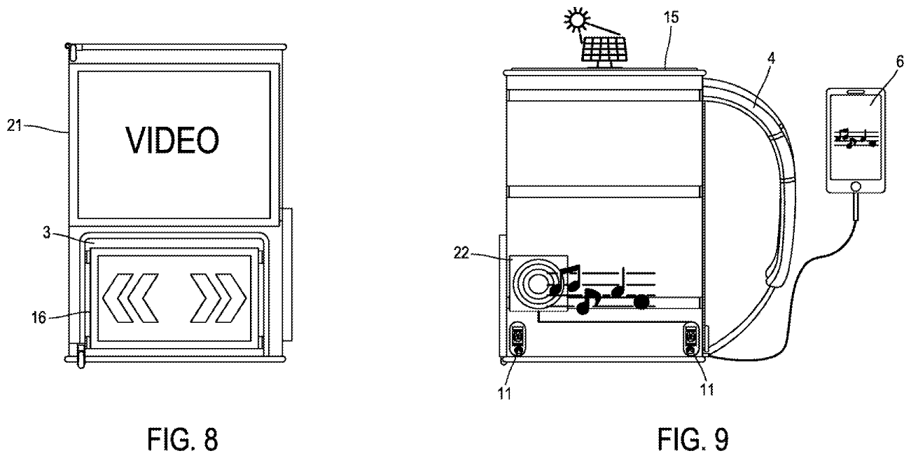

FIG. 8 shows additional features of the invention: at least one video screen 21 can be placed on one of the outer faces of the connected bags; the screen or screens are powered by an internal power source 9 or by at least one solar panel 15, via at least one USB jack port 11 (not represented in FIG. 8). The video screen or screens 21 are preferentially fixed removably onto the outer face or faces of the connected bag. The video data are transmitted via the USB jack port or ports. Obviously, all kinds of images can be displayed, but, preferably, the videos displayed are intended to obtain tracking, traceability and security of the transported products and/or of the carrier.

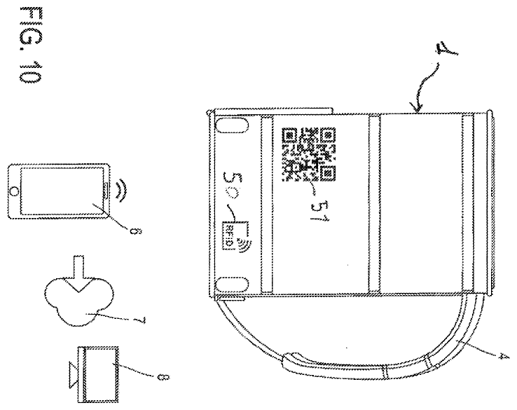

FIG. 9 illustrates an embodiment according to which speakers or equivalent audio broadcasting means 22 are fixed, preferentially removably, onto at least one of the outer faces of the connected bag. The power source can consist of at least one solar panel 15, itself fixed onto the outer face of the bag and/or a rechargeable or non-rechargeable battery. The audio data are then transmitted by the connection of a device of smartphone 6 type, via a USB jack port 11.

FIG. 10 illustrates an embodiment of the bag according to the invention, according to which the bag according to the invention comprises an RFID chip 50 and the code of QR 51 type associated with the RFID chip 50. The RFID chip 50 is incorporated in the bag according to the invention at the time of its production. For example, the RFID chip 50 is incorporated in a thickness of the envelope 1 of the bag according to the invention. A QR code 51 associated with the RFID chip is applied to an outer surface of the envelope 1, so that the QR code 51 can be read by a smartphone 6. Such incorporation of an associated RFID chip 50 and QR code 51 makes it possible to implement a traceability of the bag according to the invention and of its content between the moment when the content is introduced into the bag according to the invention and the moment when the content, having arrived at its destination, is removed from the bag according to the invention. In fact, when the bag according to the invention is being filled, a first pairing is produced between the bag according to the invention and its content which has just been introduced therein, by the reading of the QR code 51 associated with the RFID chip 50: thus, the content of the bag according to the invention is associated with the identification information of the RFID chip 50. This first pairing can be performed by an application implanted on a device of smartphone 6 type. Next, a second pairing is performed between the filled bag according to the invention and a dispatch rider appointed to perform the transportation of the bag according to the invention and its content to the delivery destination: for that, the identification information of the RFID chip 50 is associated with an account of the dispatch rider via an application implanted on a device of smartphone 6 type thereof. The set of data containing information from the preceding pairings is transmitted and/or stored to a given “cloud” and thus supplies information in real time to a particular reception means 8: for example a device of smartphone 6 type of the recipient of the content of the bag according to the invention. The recipient can then check the traceability of the content of the bag according to the invention. That also makes it possible to put in place a real tracking of the content between the bag according to the invention and the dispatch rider responsible for the transportation thereof.

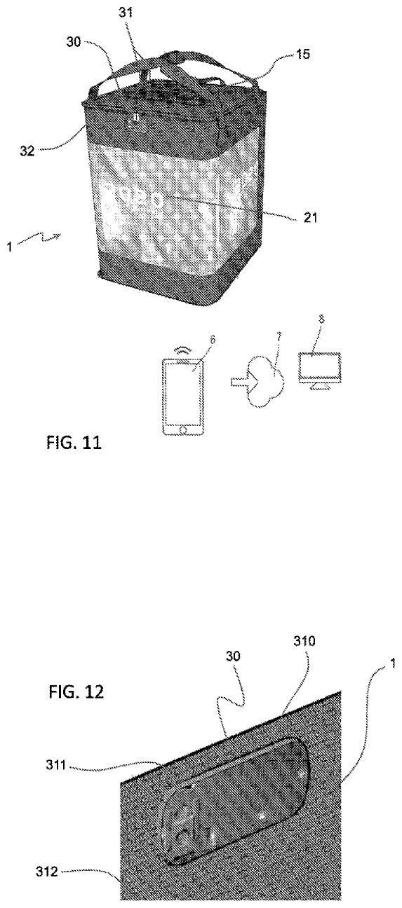

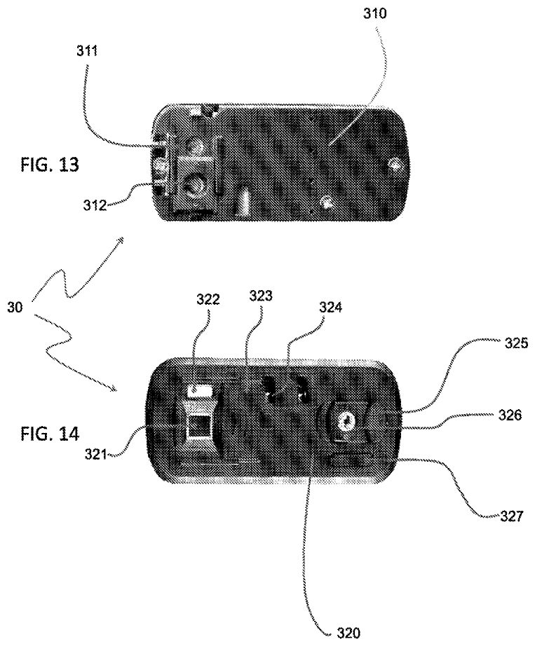

FIGS. 11 to 14 illustrate an embodiment of the bag 1 according to the invention according to which the bag 1 according to the invention comprises a security device 30 securing a closed configuration of the bag 1 according to the invention, the security device 30 being arranged so as to cooperate with the opening means 3 of the bag 1 according to the invention. Such a security device 30 allows the bag 1 according to the invention to be opened only by an authorized user prestored in said security device 30. This authorized user is primarily the carrier/owner of the bag 1 according to the invention. In the embodiment illustrated here, the bag 1 according to the invention comprises a flexible screen 1 extending over three faces of said bag 1 according to the invention, which here is of globally parallelepipedal form. Also, the security device 30 can communicate with a device of smartphone 6 type. In particular, a pairing is thus performed between the security device 30 of the bag 1 according to the invention, for example filled, and a dispatch rider appointed to perform the transportation of the bag 1 according to the invention and its content from a place of removal intended for delivery: for that, identification information of the security device 30 is associated with an account of the dispatch rider via an application implanted on a device of smartphone 6 type thereof. The set of data containing the pairing information is transmitted and/or stored to a given “cloud” 7, and thus supplies information in real time to a particular reception means 8: for example, as previously, a device of smartphone 6 type of the recipient of the content of the bag 1 according to the invention. The recipient can then check the traceability of the content of the bag 1 according to the invention. That also makes it possible to put in place a real tracking of the content between the bag 1 according to the invention and the dispatch rider associated therewith during the abovementioned pairing and responsible for the transportation thereof.

Here, the bag 1 according to the invention comprises, in order to allow or prevent access to its internal space that it delimits by its envelope, and do so in a manner that is known per se, a zipper 32 closure comprising two shuttles 31 mounted symmetrically with respect to one another and each comprising a maneuvering tongue, itself comprising an eyelet, all of which forms the opening means 3. The security device 30 is then formed in a thickness of the enclosure of the bag 1 according to the invention in the vicinity of the Éclair closure 32. On an inner face 310, the security device 30 comprises a first button 311 and a second button 312. The first button 311 makes it possible to reset the identification information associated with the person authorized to use the security device 30. The second button 312 makes it possible to store in the security device 30 identification information associated with the person who will be authorized to use the security device 30. That makes it possible to perform the pairing between the security device 30 of the bag 1 according to the invention, for example filled, and a dispatch rider appointed to perform the transportation of the bag 1 according to the invention and its content, a pairing which can then be transmitted to the device of smartphone 6 type of said dispatch rider as previously described.

On an outer face 320 of the security device 30 of the bag 1 according to the invention, the security device 30 here comprises a reader 321 of identification information, for example a reader of biometric information such as a reader of fingerprints of the person authorized or to be authorized to use the bag 1 according to the invention. The reader 321 is used to perform the pairing with said person to be authorized or to unlock an opening of the bag 1 according to the invention. Also, the security device 30 can comprise an operation indicator 322, herein the form of an LED. Furthermore, the security device 30, comprises retaining means 323, 324 for retaining the tongues of the shuttles 31 when the latter are in contact with one another in line with the security device 30, the bag 1 according to the invention being then in closed configuration. The retaining means here comprise retaining hooks 324 for retaining the tongues via their respective eyelet and a cover 323 that is movable between an unlocking position (illustrated in FIG. 14) allowing the tongues of the shuttles 31 to be free from the hooks 324, and a locking position in which the cover 323 covers the hooks 324, locking the tongues of the shuttles 31 in place engaged with the hooks 324. The transition from one position to the other, and in particular that from the locking position to the unlocking position, is performed by pressure on a trigger 325 formed for that purpose on the outer face 320 of the security device 30. However, in this case, the trigger 325 is active only if the identification information read, concomitantly or just before, by the reader 321 corresponds to that of the authorized person previously stored in the security device 30. A mechanical backup system 326, such as a keylock is provided in case of malfunction or failure of the security device 30.

As a variant, the security device 30 comprises a USB type port for the wired connection of a device of smartphone 6 type.

Without departing from the invention, it is possible to provide a video camera fixed onto a shoulder strap 4 of the bag, cooperating functionally with a light source of LED type fixed for example onto another shoulder strap 4. The carrier can thus be seen, filmed in the course of his or her work for the purposes of protection and/or traceability, both for himself or herself and for the fragile objects or products that he or she is transporting.

Means for heating and/or cooling the internal volume of the bag are favorably provided; heating resistors or other elements capable of heating are chosen and fixed for example to the rigid or semi-rigid envelope. Likewise for refrigerating elements. A temperature control can be provided in order to regulate the temperature in the internal volume.

The persons or categories of persons likely to use the connected bag according to the invention are many and varied; food dispatch riders, first aid workers, medical personnel, firefighters, air transport personnel, veterinarians, army personnel, ramblers, climbers, travelers. The transportation of musical instruments or sporting equipment can also be cited. The invention is of interest whenever it involves transporting objects or products qualified as “fragile” in specific conditions. Furthermore, the invention allows for remote locating, monitoring and tracking of the transported objects and of the carrier himself or herself if so desired.

Obviously, the various embodiments described previously of the bag 1 according to the invention can be combined with one another so as to augment synergy between them to achieve the aim of the invention to provide tracking, traceability and security of the transported products and/or of the carrier.

1. A connected bag for transporting fragile objects comprising a rigid or semi-rigid outer envelope delimiting an internal volume, partitioning elements for partitioning said internal volume, means for opening the envelope to access the internal volume, means for linking with a carrier, the connected bag comprising a security device, arranged so as to cooperate with the opening means, comprising a reader of information identifying a person authorized to open the bag.

2. The transport bag as claimed in claim 1, wherein the transport further comprises an integrated RFID chip.

3. The transport bag as claimed in claim 2, wherein the transport bag further comprises a QR code associated with the RFID chip.

4. The transport bag as claimed in claim 1, wherein the transport bag further comprises connector link means (5, 11) capable of locating said bag and/or said carrier and/or of delivering in real time information on the objects transported, a standalone power source of battery type linked to at least one port of USB jack type.

5. The transport bag as claimed in claim 1, wherein the transport bag further comprises carrier protection means.

6. The transport bag as claimed in claim 1, wherein the information on the transported objects relate to their weight derived from at least one integrated weight sensor and/or their temperature derived from at least one temperature sensor and/or the relative humidity derived from at least one moisture sensor concerning the internal volume of the bag, the sensors being functionally linked to a processing means external to the bag and/or to a magnetic card.

7. The transport bag as claimed in claim 1, wherein the transport bag further comprises means for heating or cooling said internal volume, powered by the power source.

8. The transport bag as claimed in claim 1, wherein the transport bag further comprises display means fixed onto the outer surface of the envelope, powered or not by the power source.

9. The transport bag as claimed in claim 1, wherein the transport bag further comprises sound broadcasting means powered by the power source and capable of cooperating with digital files transmitted from at least one external source.

10. The transport bag as claimed in claim 1, wherein the transport bag further comprises at least one camera and at least one LED cooperating with the means for opening the envelope and connection means in order to control and/or record the displacements of said opening means.

11. The transport bag as claimed in claim 1, wherein the transport bag further comprises at least one camera fixed onto the outer envelope, powered by said power source and capable of recording and/or transmitting information relating to the environment of said bag in real time.

12. The transport bag as claimed in claim 1, wherein the reader is a biometric information reader.

13. The transport bag as claimed in claim 12, wherein the reader is a fingerprint reader.

14. The transport bag as claimed in claim 5, wherein the carrier protection means comprises at least one of a light sources and an airbag.
